(19) United States
(12) Patent Application Publication
(10) Pub. No.: US 2019/0296989 A1
(43) Pub. Date: Sep. 26, 2019

(54) INFORMATION TECHNOLOGY SERVICES WITH FEEDBACK-DRIVEN SELF-CORRECTING MACHINE LEARNINGS

(71) Applicants: Sandra J Racine, Dallas, WI (US); Jon Carlson, Cottage Grove, MN (US); Steven G. Buchmiller, Phoenix, AZ (US); Cynthia Deibert Shelton, Lake Oswego, OR (US); Alejandro Mendoza, Englewood, CO (US)

(72) Inventors: Sandra J Racine, Dallas, WI (US); Jon Carlson, Cottage Grove, MN (US); Steven G. Buchmiller, Phoenix, AZ (US); Cynthia Deibert Shelton, Lake Oswego, OR (US); Alejandro Mendoza, Englewood, CO (US)

(73) Assignee: Unisys Corporation, Blue Bell, PA (US)

(21) Appl. No.: 15/933,736

(22) Filed: Mar. 23, 2018

(51) Int. Cl. H04L 12/24; G06K 9/62; H04L 12/26; G06F 15/18

(52) U.S. Cl. CPC H04L 41/5067; G06K 9/6263; G06F 15/18; H04L 43/16; H04L 41/064

(57) ABSTRACT

A machine of console includes a processor and a machine readable medium accessible by the processor. The processor being adapted to execute instructions including categorizing incidents based on parameters of the incidents; identifying solutions, at least partially, based on the categorization of the incidents; measuring mean time to restoration; monitoring post-restoration incidents over a period of time; and storing effective solutions into a database corresponding to the category.

### FIELD OF INVENTION

The present disclosure generally relates to improving information technology services. More specifically, the present disclosure relates to automatically improving information technology services by using feedback driven self-correcting machine learnings.

### BACKGROUND OF THE INVENTION

Current evaluations of information technology services focus on a single factor: the expressed satisfaction. This satisfaction is a subjective feeling end users have toward the information technology service she or he had received. This satisfaction is often measured by the voluntary participation in a point-based survey after the end user has experienced the service. There are several problems with this type of evaluation. First, expressed satisfaction is a subjective, one dimensional measurement, focusing on a single factor, “a feeling of satisfaction” to determine the quality of the services. Second, the factor of being satisfied or not is emotional and subjective. Thus, it is open to challenges in measurement and accuracy. Third, the use of surveys, especially voluntary participation, can often result in a statistically insignificant participation. Fourth, satisfaction survey participation often occurs only when the experience is very good or very bad, further skewing the accuracy of the results.

Currently, in the information technology servicing industry, human inputs from either the client side, or the service provider side, or sometimes both are required for gauging client satisfaction. There is currently no method that can systematically and automatically identify a cause of client dissatisfaction without human input. Further, there is currently no method that is capable of providing a systematic solution to resolve the uncovered cause of the dissatisfaction.

The current disclosure discloses embodiments related to information technologies that can systematically identify a cause of client dissatisfaction. The identification process may be automatic without human input, or it may be semi-automatic with limited human input. The embodiments disclosed herein are capable of, without human interference, providing a systematic solution to resolve the cause of the dissatisfaction. The disclosure includes embodiment that involves machine learnings. The embodiments disclosed herein avoid the subjective, one dimensional satisfaction survey from clients. The embodiments disclosed herein are feedback driven machine learning methodologies, without asking for emotional, subjective responses from humans. The embodiments disclosed herein avoid the issue of insignificant sampling stemming from the volunteering nature of the satisfaction survey.

Further, current state of the art has no automatic method in categorizing information technology incidents. Currently, the customer care personnel working for the information technology service provider has to talk to the client or vender to figure out what is the root cause of the incident and then categorize the incident based on his/her own experience. Thus, the categorization of incident is currently a manual and subjective process. By contrast, the embodiments disclosed herein are using a console with machine learning algorithms that can automatically categorize the incidents. Such console with machine learning algorithms has the advantages of eliminating human bias, increasing classification efficiency, increasing the processing throughput, and reducing internet or phone call traffic. Further, the console with machine learning algorithms disclosed herein is a feedback-driven self-correcting machine. Therefore, the accuracy of the decisions made by the console will gradually become more accurate over time.

### SUMMARY OF THE INVENTION

The present disclosure generally relates to improving information technology services. More specifically, the present disclosure relates to automatically improving information technology services by using feedback driven self-correcting machine learnings.

The current disclosure discloses embodiments related to information technologies that can systematically and automatically identify a cause of client dissatisfaction without human input. The embodiments disclosed herein are capable of, without human interference, providing a systematic solution to resolve the cause of the dissatisfaction. The disclosure includes embodiment that involves machine learnings. The embodiments disclosed herein avoid the subjective, one dimensional satisfaction survey from clients. The embodiments disclosed herein are feedback driven machine learning methodologies, without asking for emotional, subjective responses from humans. The embodiments disclosed herein avoid the issue of insignificant sampling stemming from the volunteering nature of the satisfaction survey.

In one embodiment, a console configured for automatically classifying incidents and providing effective solutions to information technology incidents includes a processor and a machine readable medium accessible by the processor. The processor being adapted to execute instructions including categorizing incidents based on parameters of the incidents; identifying solutions, at least partially, based on the categorization of the incidents; measuring mean time to restoration; monitoring post-solution incidents over a period of time; and storing effective solutions into a database corresponding to the category.

In one embodiment, a machine readable memory medium of a console including instructions when executed cause a processor of the console to perform the following actions: categorizing incidents based on parameters of the incidents; identifying solutions, at least partially, based on the categorization of the incidents; measuring mean time to restoration; monitoring post-solution incidents over a period of time; and storing effective solutions into a database corresponding to the category.

In another embodiment, a method of controlling a console having a processor, the method comprising categorizing incidents based on parameters of the incidents; identifying solutions, at least partially, based on the categorization of the incidents; measuring mean time to restoration; monitoring post-solution incidents over a period of time; and storing effective solutions into a database corresponding to the category.

Other objects, features and advantages disclosed herein will become apparent from the following figures, detailed description, and examples. It should be understood, however, that the figures, detailed description, and examples, while indicating specific embodiments of the invention, are given by way of illustration only and are not meant to be limiting. Additionally, it is contemplated that changes and modifications within the spirit and scope of the invention will become apparent to those skilled in the an from this detailed description.

### BRIEF DESCRIPTION OF THE DRAWINGS

Advantages of the present invention may become apparent to those skilled in the art with the benefit of the following detailed description and upon reference to the accompanying drawings.

FIG. 1 shows a method of a console implementing a feedback-driven self-correcting machine learning algorithm according to one embodiment.

FIG. 2 shows a schematic diagram of a feedback-driven self-correcting machine learning console system.

FIG. 3 shows an example of incident analysis and tracking according to one embodiment.

FIG. 4 shows a problem management process flow according to one embodiment of the disclosure.

FIG. 5 shows a knowledge management method according to one embodiment of the disclosure.

FIG. 6 shows a lifecycle management of a click-to-fix solution according to one embodiment of the disclosure.

FIG. 7 illustrates a computer network for obtaining access to database files in a computing system according to one embodiment of the disclosure.

FIG. 8 illustrates a computer system adapted according to certain embodiments of the server and/or the user interface device according to one embodiment of the disclosure.

FIG. 9A is a block diagram illustrating a server hosting an emulated software environment for virtualization according to one embodiment of the disclosure.

FIG. 9B is a block diagram illustrating a server hosting an emulated hardware environment according to one embodiment of the disclosure.

While the invention is susceptible to various modifications and alternative forms, specific embodiments thereof are shown by way of example in the drawings. The drawings may not be to scale.

### DETAILED DESCRIPTION OF THE INVENTION

While the invention is susceptible to various modifications and alternative forms, specific embodiments thereof are shown by way of example in the drawings. The drawings may not be to scale.

A “console” means a computing system implementing machine learning algorithms that can detect incidents that cause client dissatisfactions and provide a solution to resolve those incidents. A console includes one or more processors and one or more machine readable memory mediums accessible to the processors. The processors and the one or more machine readable mediums of the console are not necessarily located in one physical location and can be connected through internet.

An “incident” means an inquiry from a vendor or client seeking technical help regarding information technology related products, for example, a graphical interface using problem, a internet connection problem, a software authentication/verification problem, a data backup problem, a software usage problem, etc.

A “client” means an end user that receives informational technology services. A “vendor” means a software provider that a client is using, e.g., Microsoft, Google, Unisys, etc. The embodiments herein disclosed are providing totality solutions to a clients' incident regardless of whether the incident is caused by software of any vendor.

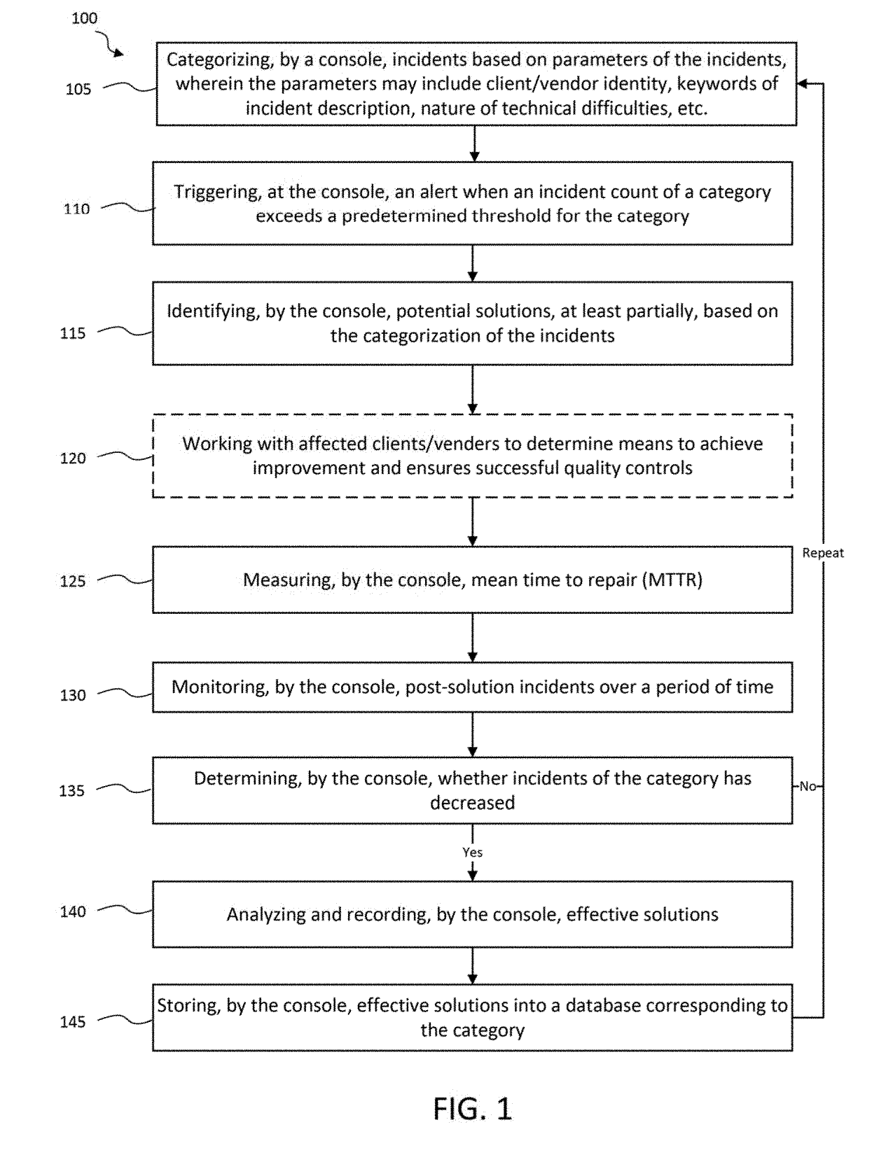

FIG. 1 shows a method 100 implementing a feedback-driven self-correcting machine learning algorithm according to one embodiment.

The method 100 includes step 105 which categorizes, by a console, incidents based on parameters of the incidents, wherein the parameters may include vendor identity, keywords of incident description, nature of technical difficulties. The incidents mean an inquiry from a vendor or client seeking technical help regarding information technology related products. For example, the incidents can be a graphical interface using problem, a internet connection problem, a software authentication/verification problem, a data backup problem, a software usage problem, or the like.

The parameters of the incidents refers to descriptors of the nature of the incidents. For example, one parameter can be Yes/No on whether the incident is an internet connection issue. For example, one parameter can be Yes/No on whether the incident is a software usage issue. For example, one parameter can be Yes/No on whether the incident is a data backup issue.

In other embodiments, the parameters can include the identity of the vendor/client, the employee number of the person who made the request, the internet protocol (IP) address, or the like. In other embodiment, the parameter can include the method the incident was made, e.g., by phone, by fax, by online form, by mail, etc.

In other embodiments, the parameters can be keywords of the incident descriptions. The keywords may be automatically extracted by the console from the incident description. For example, the console can extract keywords from an oral communication between a client and a service provider over the phone, either in real-time or from recorded sound track. In another example, the console can extract keywords from an online incident description form filled out by a client. In another example, the console can extract keywords from a fax, an electronic document, or a paper document, wherein optical character recognition are performed if necessary.

Based on the parameters of the incidents, the console characterizes the incidents. In one embodiment, categories can be a fixed set. In another embodiment, categories can be flexible. In one embodiment, the console can learn from the reported incidents and create a new category if none of the existing categories fits some of the incidents.

Depending on the categories, each parameter may have different weight in the categorization process. In one embodiment, the categories may include: internet connection, authentication, software application usage, webpage support, data backup. In these categories, the keywords of the incident description may have a predominant weight over other parameters.

It should be noted that currently, in the state of the art, there is no automatic method in categorizing incidents. Currently, the customer care personnel has to talk to the client or vender and figure out what is the root cause of the incident and then categorize the incident based on his/her own experience. Thus, the categorization of incident is currently a manual and subjective process. By contrast, the embodiments disclosed herein are using a console with machine learning algorithms that can automatically categorize the incidents. Such console with machine learning algorithms has the advantages of eliminating human bias, increasing classification efficiency, increasing the processing throughput, and reducing internet or phone call traffic. Further, the console with machine learning algorithms disclosed herein is a feedback-driven self-correcting machine. Therefore, the accuracy of the decisions made by the console will gradually become more accurate over time.

In one embodiment, the categorization can be expressed as follows. Incident categorization can be a task of assigning a Boolean value to each pair <dⱼ, cᵢ>ϵD×C, where D is an incident and C={c₁, c₂, . . . cᵢ . . . } is a set of defined categories. A true value (T) assigned to <dⱼ, cᵢ> represents a decision that incident dⱼ is classified as category cᵢ. A false value (F) assigned to <dⱼ, cᵢ> represents a decision that incident dᵢ is not classified as category cᵢ. In one embodiment, a single dⱼ can only be assigned to a single category cᵢ. In another embodiment, a single dⱼ can only be assigned to multiple categories cᵢ.

Each incident dⱼ includes a plurality of parameters P(dⱼ)={p₁, p₂ . . . pₖ}. In the categorization process, each parameter may have different weight according to its credibility value regarding a specific category. A weighted incident can be expressed as \vec{dⱼ}=(w₁p₁, w₂p₂, . . . wₖpₖ). With weighted incident, the classification process can be expressed as, <\vec{d}ⱼ, cᵢ>ϵ\vec{D}×C. Such weighted processes of automatic classification of incidents did not exist before this disclosure.

In another embodiment, the categories may include: Microsoft applications, Google applications, Unix applications, etc. In these categories, the vendor of the application may have a predominant weight over other parameters in the process of categorization.

The method 100 includes step 110 which triggers, at the console, an alert when an incident count of a category exceeds a predetermined threshold for the category. An IT service provider's computational resources are limited. It is virtually impossible for a console to have sufficient computational resources to solve all the incidents as soon as they arrive. Step 110 is to ensure that computational resources of a console are devoted to resolve the most significant categories of incidents.

The predetermined threshold may be different for each category. For example, a category of incidents that is related to a systematic network failure may have a much lower triggering threshold than a graphical interface usage issue.

The method 100 includes step 115 which identifies, by the console, potential solutions, at least partially, based on the categorization of the incidents. In some embodiment, the solutions may be recorded in an electronic database. For example, similar incidents happened before, thus similar solutions can be applicable.

In other embodiments, the solutions may be created with human inputs. For example, a special task force may be organized by a service provider to specifically resolve the incidents. The newly created solution may be later added to a knowledge database.

Optionally (as indicated in dashed box at step 120), the method 100 may optionally include step 120, wherein a task force may work with affected clients or vendors to determine means to achieve improvement and ensures successful quality controls. The solutions to the incidents may include implementing new software. The new software will need to go through sufficient quality control. One potential quality control includes user acceptance testing (UAT) known to the IT industry.

In another embodiment, the quality control can be done by programming a specifically designed software program. For example, this quality control software can mimic the operations of clients that originally cause the incidents. The control software can systematically test the solution provided by the console to ensure the quality of the solution.

The method 100 includes step 125 which measures, by the console, mean time to repair (MTTR), also known as mean time to restoration. MTTR can be a feedback signal to improve the console. In some embodiments, the shorter the MTTR the better. In some embodiments, a balance between limited computational resource, human resource, financial resource, and a reasonable MTTR is desired.

The method 100 includes step 130 which monitors, by the console, post-solution incidents over a period of time. In one embodiment, the goal of the console for providing a solution is to reduce the occurrence of similar incidents. The period of time can be a week, a month, six months, etc.

The method 100 includes step 135 which determines, by the console, whether incidents of the category has decreased. If “yes,” the method 100 moves to step 140. If “no,” the method 100 circles back to step 105 to find another solution. This is a feedback-driven self-correcting methodology that finds the effective solution for the incidents.

The determination of solution effectiveness may include a second predetermined threshold that is lower than the alert triggering threshold. In such embodiments, if the incident count is lower than the second predetermined threshold, the solution is considered effective.

The method includes step 140 which analyzes and records, by the console, effective solutions. Table 1 shows an example of analyzing the solutions.

The method includes step 145 which stores, by the console, effective solutions into a database corresponding to the category.

In another embodiment, the console focused on overall incident analysis, or analysis of issues as identified by end users making contact with support vehicles. The support vehicles can include accessing a form of self-help, online questionnaires, sending email, reaching out to the call center service desk, or the like. In this analysis, the console categorizes incidents by vendors affected with the largest incident counts becoming targets for improvements using shift best opportunities (“shift best” means focusing the resolution to the most appropriate resolution team, based on both cost/resolution and customer need). Improvements can include use of automation, such as system-based password resets, shifting resolution to less cost resolver groups such as self-help, and shifting resolution immediately to application resolver teams. The console assigns the most appropriate improvement for the target to the vendor and then works with the vendor to determine the means to achieve the improvement, such as providing more access to either end users or the resolver groups, increasing resolver training or end user awareness, or creating automation scripts. The console ensures quality control testing is successfully completed before deployment of the solution. The console measures improvement based on reduction of mean time to repair (MTTR) and increase in customer satisfaction as determined by survey. When target incidents are improved, the process repeats with the next round of incident analysis so that improvement is continuous.

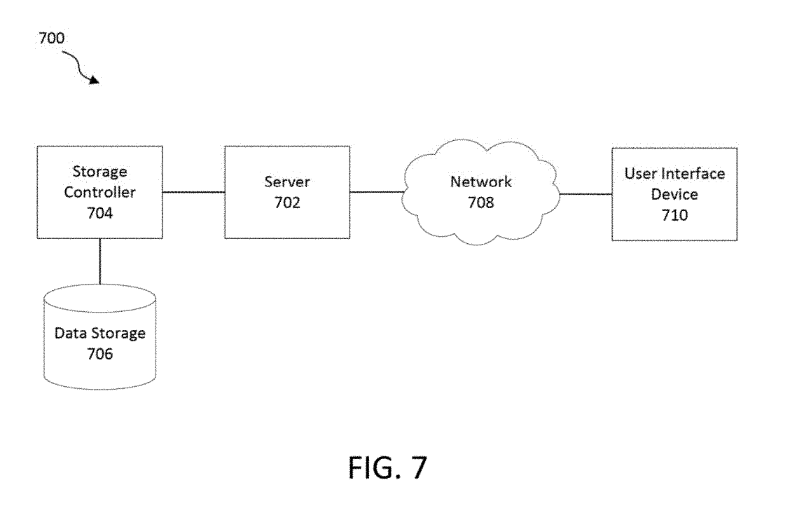

The console of method 100 can be a software application running on a user interface device 710 as shown in FIG. 7 that utilizes the network 708, the server 702, the storage 704, and data storage 706. The hardware portion of the console of method 100 may include general computer elements to perform the novelties as described in the background section of this disclosure.

The console of method 100 if implemented in firmware and/or software, the functions described above may be stored as one or more instructions or code on a computer-readable medium. Examples include non-transitory computer-readable medium encoded with a data structure and computer-readable medium encoded with a computer program. Computer-readable medium includes physical computer storage media. A storage medium may be any available medium that can be accessed by a computer. By way of example, and not limitation, such computer-readable medium can comprise RAM, ROM, EEPROM, CD-ROM or other optical disk storage, magnetic disk storage or other magnetic storage devices, or any other medium that can be used to store desired program code in the form of instructions or data structures and that can be accessed by a computer. Disk and disc includes compact discs (CD), laser discs, optical discs, digital versatile discs (DVD), floppy disks and blu-ray discs. Generally, disks reproduce data magnetically, and discs reproduce data optically. Combinations of the above should also be included within the scope of computer-readable medium.

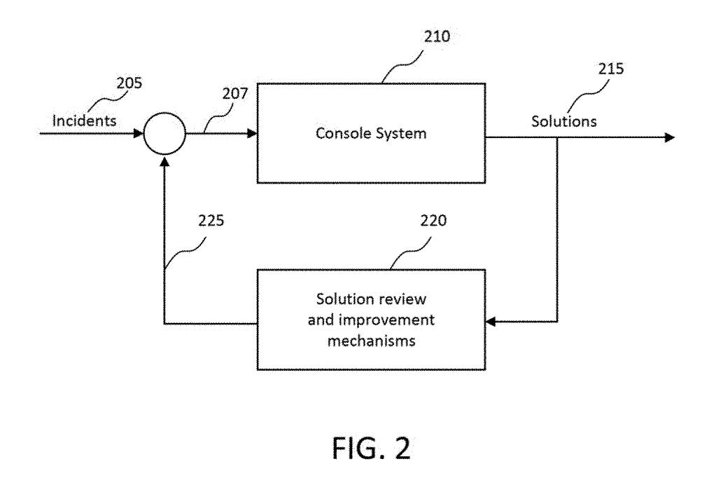

FIG. 2 shows a schematic diagram of a feedback-driven self-correcting machine learning console system. The console system 210 has an input 207. The input 207 is a mixture of incidents 205 and reviewed solutions 225. The console 210 takes in the input 207 and provides solutions 215 as output.

The incidents 205 are inquiries from a vendor or client seeking technical help regarding information technology related products, for example, a graphical interface using problem, a internet connection problem, a software authentication/verification problem, a data backup problem, a software usage problem, etc. The goal of the console system 207 is to provide solutions 215 that can reduce the occurrence of the incidents 205.

The console system 210 may implement all steps of method 100. The console system 210 can categorize the incidents as described in 105. The console system 210 can trigger an alert when an incident count of a category exceeds a predetermined threshold as described in 110. The console system 210 can identify potential solutions, at least partially, based on the categorization of the incidents as described in 115. The console system 210 can work with clients to improve the solution as described in 120. The console system 210 can measure MTTR as described in 125. The console system 210 can monitor post-solution incidents over a period of time as described in 130. The console system 210 can determine whether incidents of the category has decreased as described in 135. The console system 210 can analyze and record effective solutions as described in 140. The console system 210 can store effective solutions into a database corresponding to the category as described in 110.

The solutions 215 provided by the console system 210 can be reviewed and improved upon at the feedback block of solution review and improvement mechanisms 220, hereinafter “feedback block 220.” The feedback block 220 may include some steps of the method 100. For example, working with affected clients/venders to determine means to achieve improvement and ensures successful quality controls as described in 120; measuring MTTR as described in 125; monitoring post-solution incidents over a period of time as described in 130; determining whether incidents of the category has decreased as described in 135; analyzing and recording effective solutions as described in 140; storing effective solutions into a database corresponding to the category as described in 145.

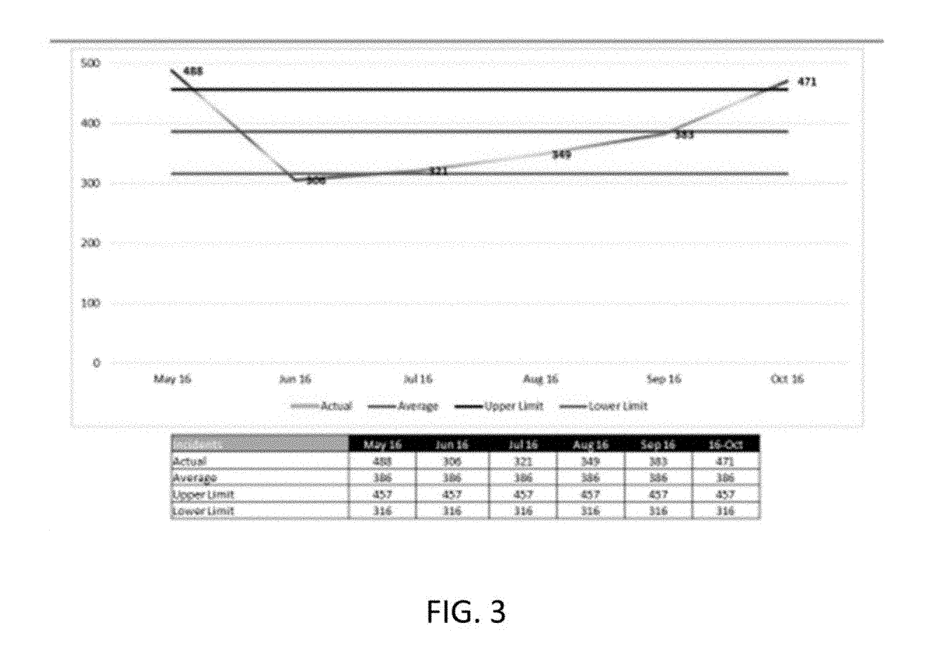

FIG. 3 shows an example of incident analysis and tracking according to one embodiment. As shown in FIG. 3, the upper limit (Y axis: 457 incident counts) can be the threshold that triggers the alert at step 110. The lower limit (Y axis: 316 incident counts) can be the threshold that determines the effectiveness of the solution at step 135.

As shown in FIG. 3, the incident count is on an upward trend since June, 2016. The majority of incidents may be categorized as “functionality error-single user” with sub-categories of “logic/code/workflow” or “single user service.” Leading contributors to incident volume stemming from these service calls are users needing assistance completing electronic signoff of courses and general assistance with navigation and clearing cache.

As shown in FIG. 3, the incident count in October, 2016 is noticeably higher. In one example, the users reported issues with webpages not loading. Root cause was isolated to a software version update that takes more than three hours. Update session was terminated to resolve the issue.

In another embodiment, database blocking session causes slowness for users logged in. One solution is to terminate the database blocking session. Another solution is to block the database at a time period that less people are affected. Yet, another solution is to clear user's cache.

The console reviews opportunities to improve periodically, e.g., daily and weekly, and reviews progress on improvements monthly with the affected vendor, and finally reviews quarterly as part of the Multivendor Governance Forum, a forum that governs the management of providing services from different vendors to the clients. Of importance to note, the customer participates in all reviews, all analysis, selection, improvement, measurement, and results is led by the owner of the Business Enablement Platform.

Table 1 provides an example of tracking for multiple targets according to one embodiment of the disclosure. In Table 1, “SD” means Service Desk; “CI” means Configuration Items; “EDM” means Electronic Documentation Management; “ADM” means Administrative Management resolvers; “Shift Left” means framework designed to improve the speed of each transaction by targeting resolution improvements of directly reported issues to the most cost-effective level in the Service Desk escalation chain. The Shift Left framework drives resolutions to lowest point of support cost and increases overall resolution rates; “LMES” means Lab Management Enterprise System; “ALM” means Asset Liability Management; “ELN” means Electronic Lab Notebook; “KB” means Knowledge Base Articles; “KM” means Knowledge Managers; and “PD” means Physical Data.

Multivendor governance is expanded by having a task force to focus on larger improvement topics such as overall process, market advancements, leading edge technology, and experience from other customer installations. The task force is composed of the seven largest vendors serving the customer and is monitored by the customers' Vendor Management Team. The group identifies topics for improvement that are fundamental to services, such as portal access or breakdown in tracking and awards. Following the same process above, issues are identified by size of impact, improvements and means to achieve are identified, and appropriate measures are tracked until achievement. Process is tracked in weekly, monthly and quarter reviews as above.

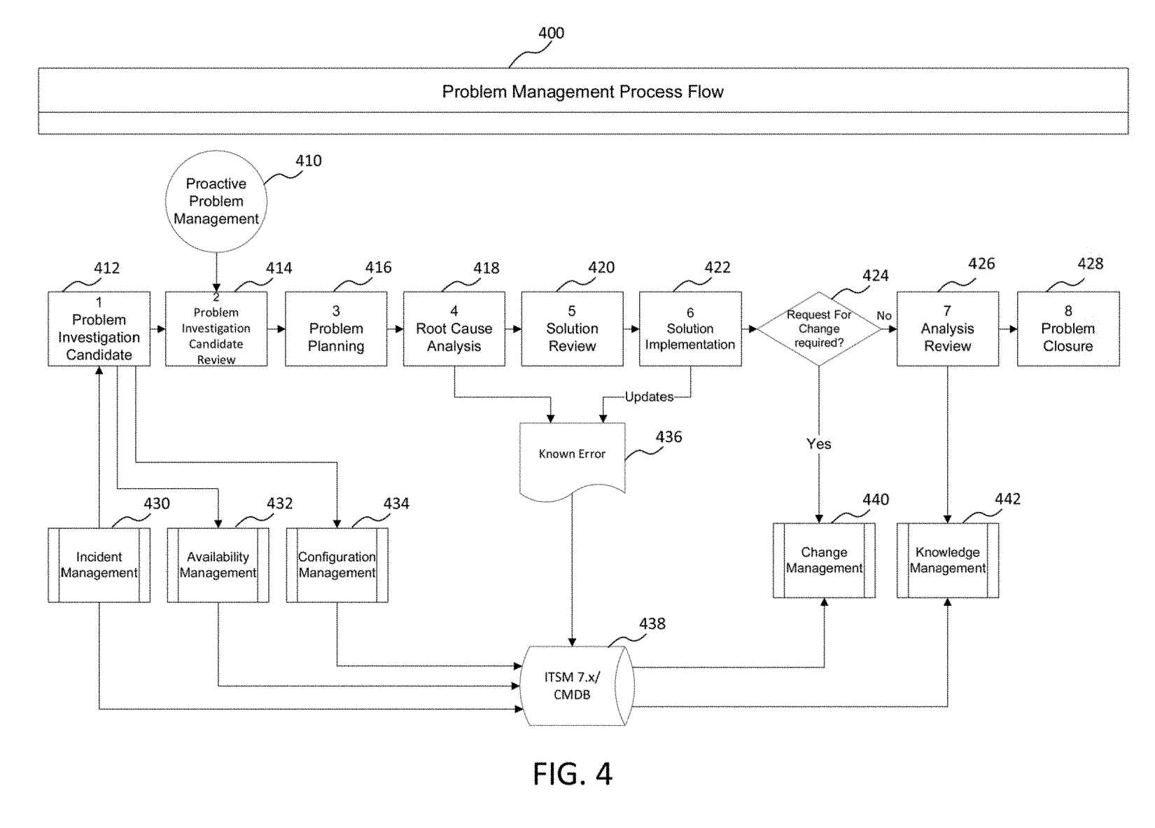

FIG. 4 shows a problem management process flow 400 according to one embodiment of the disclosure. The flow is a process of problem solving algorithm performed by the console. The flow 400 includes a number of Problem Investigation candidates 412 that initiate the process 410 that are proactive in nature instead of reactive. In this manner, the process is improved before end user performance is affected. Proactive candidates result from the continuous improvement analysis conducted by the Multivendor Governance Council and can include incidents that are recurring, are repeatedly using a known error or work around, or are identified by the Market Place Group as having significant impact on a priority group of customer end users.

At 412, the problem investigation candidates are collected. At 414, the candidates are proactively evaluated by the console. At 416, the console plans to solve the problem. At 418, the root cause of incidents are analyzed. At 420, the potential solution is being reviewed. At 422, actual steps of the implementation of the solution is planned. At 424, “RFC” means Request For Change. At 426, analysis is reviewed. At 428, the problem is solved and closed down.

At 440, the management is changed. Step 442 is knowledge management. Step 436 is identified known errors. Step 430 is incident management. Step 432 is availability management. Step 434 is configuration management. Step 438 is recording in database.

With the Business Enablement Platform, we focus on Continuous Improvement as a Service by identifying opportunities to improve support performance and experience through Business Intelligence Analytics. We use data to analyze, anticipate, and pinpoint each persona's ability to be successful in their business roles. Three examples of how support performance and experience were improved using analytics are discussed below:

In one embodiment of a problem solving: for a window and door manufacturing company in the Midwest, the console identified a large quantity of product defect failures and a long MTTR for a unique persona group: the customer's sales team working from Home Depot stores across Midwest states. After additional analysis of the support process for this persona, several improvement initiatives were implemented that reduced both product defect failures and MTTR.

For one recurring incident, the high failure rate of the tablet PC, it was discovered that the customer's sales team was using a corporate image that had not been tested and approved for release in the customer's production environment. Our Program Management brought this forward to the customer's IT management and engaged our End Point Delivery team to create an image for the tablet PC and performed User Acceptance Testing (UAT) to demonstrate it was ready to go through the change approval process and be released for production use.

For the MTTR, console analysis of the extended MTTR identified that the remote sales team resources residing in the Home Depot stores were using a secure Virtual Private Network connection to the Customer's internal network and attempting to load their bid estimator application updates from an application server within the firewall and the customer's secured network. The downloads were large and the access was constrained causing the downloads to fail and the customer's sales team to send their tablet in for repair at their corporate headquarters Kiosk. When tested within the corporate network, the updates were successful, but once it was sent back to the sales resource the problem would return. The process was repeated with the sales resource sending their tablet back to the corporate headquarters repair Kiosk. The console engaged end point management and network teams to design a cloud-based external facing application server to enable the bid estimator application updates to come from an external-facing Application Server eliminating the network constraint and the excessive MTTR.

Another embodiment of a problem solving: for a global life sciences company, console identified high volume of requests that were being performed on site for backup of the customer's end users Microsoft Outlook backup. After the Multivendor Governance Council performed the root cause analysis of the process, it was determined that this support request should be triggered to a systematic level. After reviewing the use case with the customer, the console suggests a solution to automate the support request by creating an automated script (known as Click-to-Fix) to perform the Outlook data file backup for the customer's end users. The end result was an 8% reduction of the support requests being handled on site by Unisys technicians: 6% were handled through the automated scripts and the remaining 2% were re-categorized and routed to the Service Desk agents to handle.

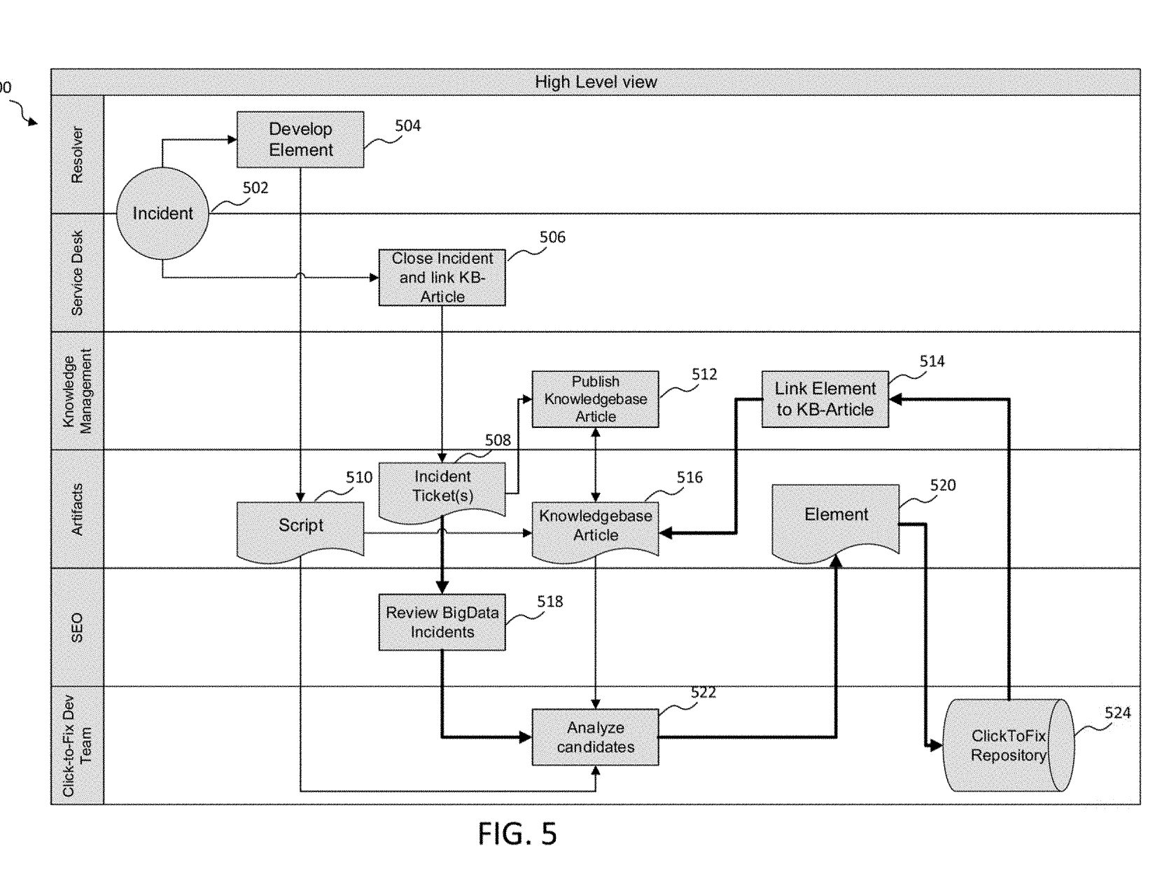

FIG. 5 shows a knowledge management method according to one embodiment of the disclosure. Block 502 represents occurrence of incidents. Block 504 represents console's developing of solution solving elements. Block 506 represents closing of the incident and docket the solution to a knowledge base article (KB-Article). Block 508 represents creation of incident ticket. Block 510 represents scripts or program codes that implements the solution. Block 512 represents publishing the knowledge base article. Block 514 represents linking the elements 504, 520 to the KB-Article. Block 516 represents KB-Article. Block 518 represents reviewing on a statistically meaningful manner, e.g., big data, of the incidents. Block 520 represents solution elements. Block 522 represents analyzing incident candidates. Block 524 represents a database that stores the solution, e.g., click-to-fix script.

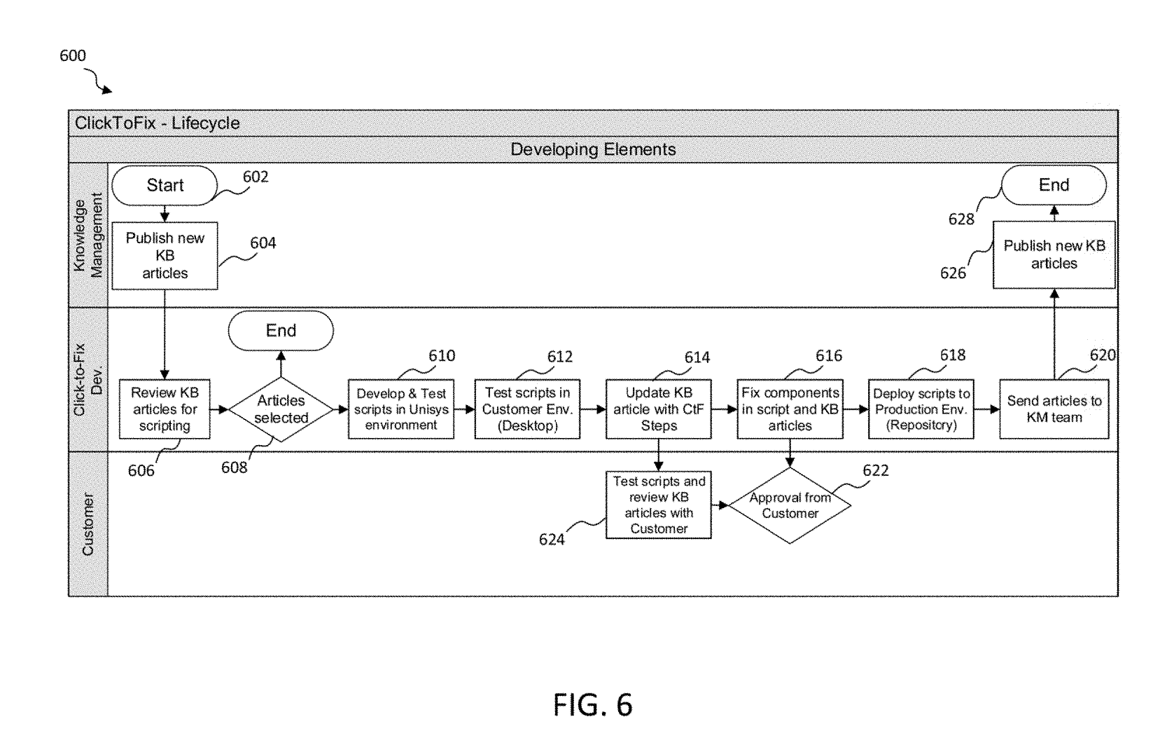

FIG. 6 shows a lifecycle management 600 of a click-to-fix solution according to one embodiment of the disclosure. As shown in FIG. 6, the lifecycle management 600 includes three phases: knowledge management, click-to-fix development, and customer.

The knowledge management includes block 602, 604, 626, and 628.

In one embodiment of incident solving: for a global commercial products account, the console identified end user support satisfaction escalation resulting from a high MTTR for Lync application support. Upon root cause analysis of the Lync calls, console discovered that a majority of the Lync incidents were categorized as Level III Application support. After a thorough review of the knowledge articles and the revision to their content structure to improve search indexing, the console proposed a change request to the customer to have a portion of the high volume incidents routed to a central management location to handle. After approval of the change request by the customer, console demonstrated a shift to more economical resolver groups of incident volumes from Level III Application support which improved the end-user support satisfaction by lowering the MTTR 60%. In addition, the solution support of Lync improved the First Call Resolution rate for the Lync applications by 20% the first month following implementation of the change request and improved it to 80% within 3 months.

The console's solution is adaptive to end-user working behaviors and patterns, creating a support landscape consistent with how end users work. With the model, console will leverage the data from the IT Service Management platform to analyze, trend, and accelerate persona's ability to engage services and achieve self-enablement to restore them to productivity faster, as illustrated in the discussions above. Using available data, console assess the factors that may be affecting their performance to determine the support needed, including how the support is delivered. Data is collected, compiled, and analyzed to identify factors affecting work performance, including the design and development of Dashboards and Reports for data consumption and analysis, the following steps and tools may be used: Identify where data is being captured and/or what Customer Relationship Management (CRM) tool is in place, such as ServiceNow or remedy; define the data warehouse (for example Amazon Redshift or Teradata); set up Extract, Transform, Load (ETL) functions using tools such as Microsoft SQL Server Integration Services; develop a data cube for data manipulation; data connection SQL Server to Business Intelligence tool, such as Power BI, or the like.

The console or Business Enablement Platform encourages and continually investigates—via topics for the Market Place Group—omnichannel access and the flexibility to respond to changes in the enterprise population, embracing consumerization and a simplified support path that is part of the workspace itself. By adjusting services to persona preference as enabled by the Business Enablement Platform, IT services can improve business productivity and serve as a catalyst to invite end users to more successful patterns, behaviors, and tools. The Business Enablement Platform will keep customers running, make every contact count, make some contacts invisible and create a natural and sometimes invisible bridge between IT offerings and end user engagement.

FIG. 7 illustrates a computer network 700 for obtaining access to database files in a computing system according to one embodiment of the disclosure. The computer network 700 may include a server 702, a data storage device 706, a network 708, and a user interface device 710. The server 702 may also be a hypervisor-based system executing one or more guest partitions hosting operating systems with modules having server configuration information. In a further embodiment, the computer network 700 may include a storage controller 704, or a storage server configured to manage data communications between the data storage device 706 and the server 702 or other components in communication with the network 708. In an alternative embodiment, the storage controller 704 may be coupled to the network 708.

In one embodiment, the user interface device 710 is referred to broadly and is intended to encompass a suitable processor-based device such as a desktop computer, a laptop computer, a personal digital assistant (PDA) or tablet computer, a smartphone or other mobile communication device having access to the network 708. In a further embodiment, the user interface device 710 may access the Internet or other wide area or local area network to access a web application or web service hosted by the server 702 and may provide a user interface for enabling a user to enter or receive information.

The network 708 may facilitate communications of data between the server 702 and the user interface device 710. The network 708 may include any type of communications network including, but not limited to, a direct PC-to-PC connection, a local area network (LAN), a wide area network (WAN), a modem-to-modem connection, the Internet, a combination of the above, or any other communications network now known or later developed within the networking arts which permits two or more computers to communicate.

In one embodiment, the user interface device 710 accesses the server 702 through an intermediate sever (not shown). For example, in a cloud application the user interface device 710 may access an application server. The application server fulfills requests from the user interface device 710 by accessing a database management system (DBMS). In this embodiment, the user interface device 710 may be a computer or phone executing a Java application making requests to a JBOSS server executing on a Linux server, which fulfills the requests by accessing a relational database management system (RDMS) on a mainframe server.

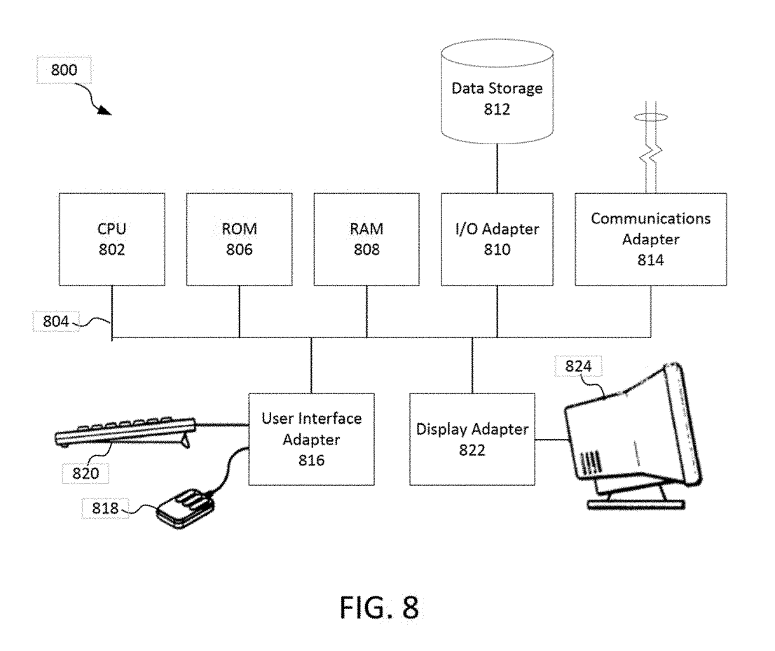

FIG. 8 illustrates a computer system 800 adapted according to certain embodiments of the server 802 and/or the user interface device 810. The central processing unit (“CPU”) 802 is coupled to the system bus 804. The CPU 802 may be a general purpose CPU or microprocessor, graphics processing unit (“GPU”), and/or microcontroller. The present embodiments are not restricted by the architecture of the CPU 802 so long as the CPU 802, whether directly or indirectly, supports the operations as described herein. The CPU 802 may execute the various logical instructions according to the present embodiments.

The computer system 800 may also include random access memory (RAM) 808, which may be synchronous RAM (SRAM), dynamic RAM (DRAM), synchronous dynamic RAM (SDRAM), or the like. The computer system 800 may utilize RAM 808 to store the various data structures used by a software application. The computer system 800 may also include read only memory (ROM) 806 which may be PROM, EPROM, EEPROM, optical storage, or the like. The ROM may store configuration information for booting the computer system 800. The RAM 808 and the ROM 806 hold user and system data, and both the RAM 808 and the ROM 806 may be randomly accessed.

The computer system 800 may also include an I/O adapter 810, a communications adapter 814, a user interface adapter 816, and a display adapter 822. The I/O adapter 810 and/or the user interface adapter 816 may, in certain embodiments, enable a user to interact with the computer system 800. In a further embodiment, the display adapter 822 may display a graphical user interface (GUI) associated with a software or web-based application on a display device 824, such as a monitor or touch screen.

The I/O adapter 810 may couple one or more storage devices 812, such as one or more of a hard drive, a solid state storage device, a flash drive, a compact disc (CD) drive, a floppy disk drive, and a tape drive, to the computer system 800. According to one embodiment, the data storage 812 may be a separate server coupled to the computer system 1000 through a network connection to the I/O adapter 810. The communications adapter 814 may be adapted to couple the computer system 800 to the network 708, which may be one or more of a LAN, WAN, and/or the Internet. The user interface adapter 816 couples user input devices, such as a keyboard 820, a pointing device 818, and/or a touch screen (not shown) to the computer system 800. The display adapter 822 may be driven by the CPU 802 to control the display on the display device 824. Any of the devices 802-822 may be physical and/or logical.

The applications of the present disclosure are not limited to the architecture of computer system 800. Rather the computer system 800 is provided as an example of one type of computing device that may be adapted to perform the functions of the server 702 and/or the user interface device 710. For example, any suitable processor-based device may be utilized including, without limitation, personal data assistants (PDAs), tablet computers, smartphones, computer game consoles, and multi-processor servers. Moreover, the systems and methods of the present disclosure may be implemented on application specific integrated circuits (ASIC), very large scale integrated (VLSI) circuits, or other circuitry. In fact, persons of ordinary skill in the art may utilize any number of suitable structures capable of executing logical operations according to the described embodiments. For example, the computer system 800 may be virtualized for access by multiple users and/or applications.

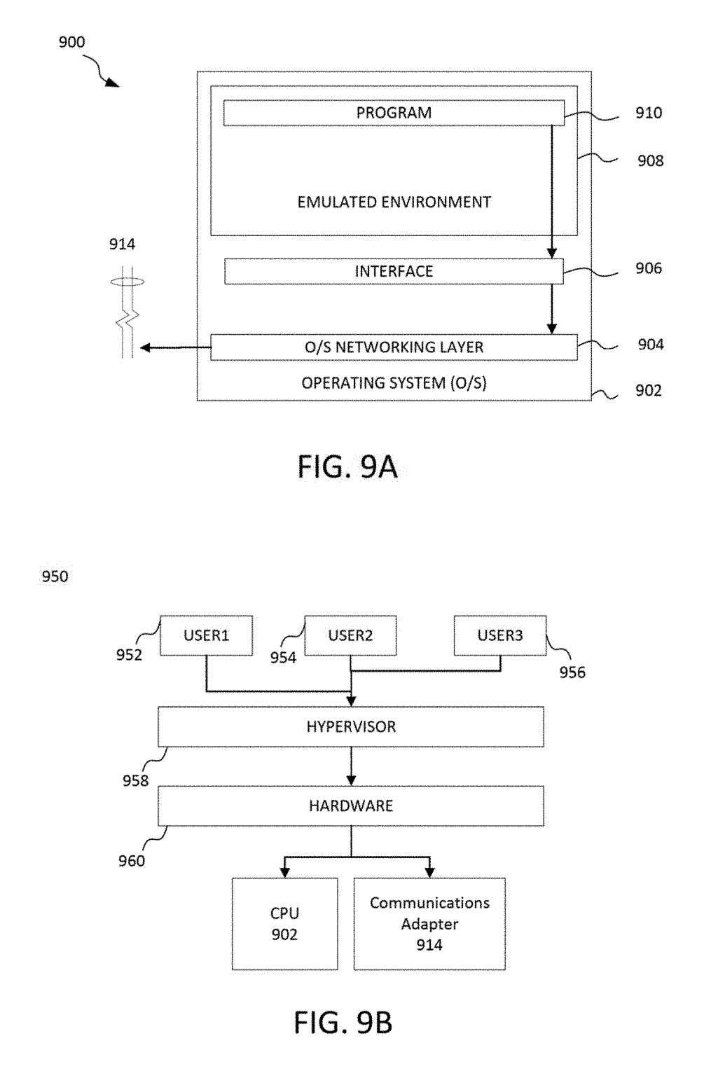

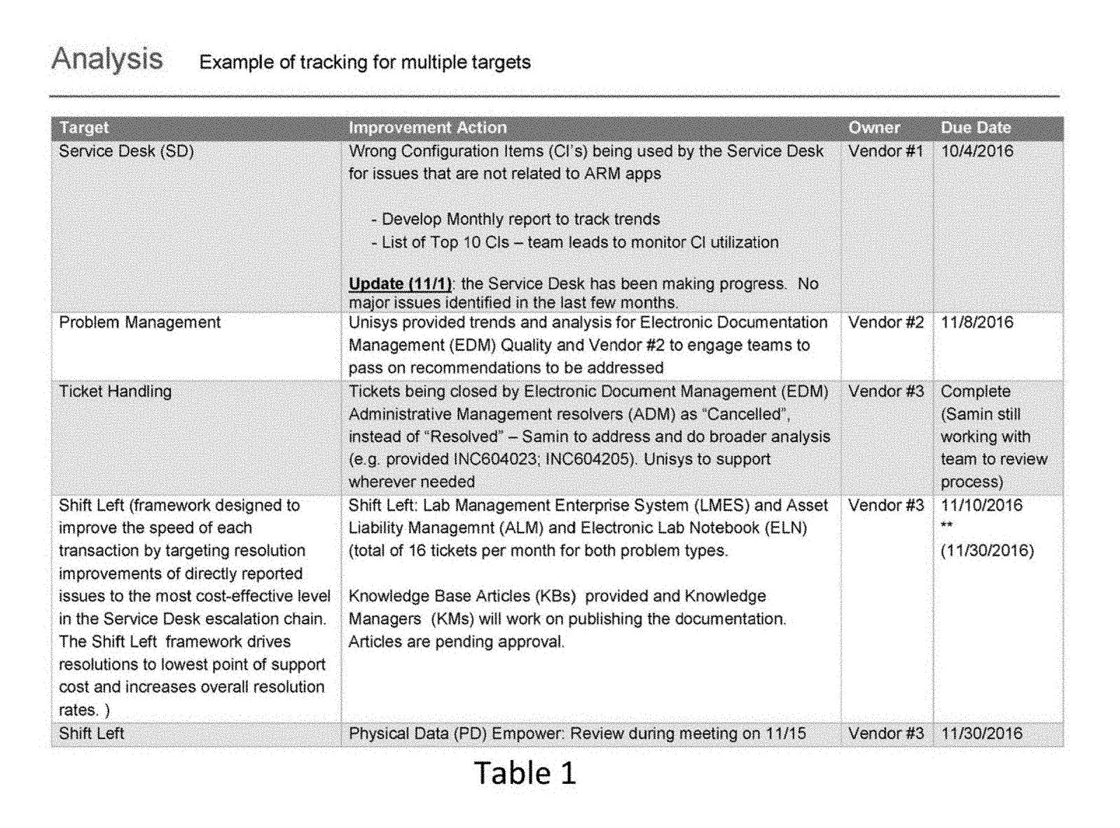

FIG. 9A is a block diagram illustrating a server 900 hosting an emulated software environment for virtualization according to one embodiment of the disclosure. An operating system 902 executing on a server 900 includes drivers for accessing hardware components, such as a networking layer 904 for accessing the communications adapter 914. The operating system 902 may be, for example, Linux or Windows. An emulated environment 908 in the operating system 902 executes a program 910, such as Communications Platform (CPComm) or Communications Platform for Open Systems (CPCommOS). The program 910 accesses the networking layer 904 of the operating system 902 through a non-emulated interface 906, such as extended network input output processor (XNIOP). The non-emulated interface 906 translates requests from the program 910 executing in the emulated environment 908 for the networking layer 904 of the operating system 902.

In another example, hardware in a computer system may be virtualized through a hypervisor. FIG. 9B is a block diagram illustrating a server 950 hosting an emulated hardware environment according to one embodiment of the disclosure. Users 952, 954, 956 may access the hardware 960 through a hypervisor 958. The hypervisor 958 may be integrated with the hardware 960 to provide virtualization of the hardware 960 without an operating system, such as in the configuration illustrated in FIG. 9A. The hypervisor 958 may provide access to the hardware 960, including the CPU 802 and the communications adaptor 914.

If implemented in firmware and/or software, the functions described above may be stored as one or more instructions or code on a computer-readable medium. Examples include non-transitory computer-readable medium encoded with a data structure and computer-readable medium encoded with a computer program. Computer-readable medium includes physical computer storage media. A storage medium may be any available medium that can be accessed by a computer. By way of example, and not limitation, such computer-readable medium can comprise RAM, ROM, EEPROM, CD-ROM or other optical disk storage, magnetic disk storage or other magnetic storage devices, or any other medium that can be used to store desired program code in the form of instructions or data structures and that can be accessed by a computer. Disk and disc includes compact discs (CD), laser discs, optical discs, digital versatile discs (DVD), floppy disks and blu-ray discs. Generally, disks reproduce data magnetically, and discs reproduce data optically. Combinations of the above should also be included within the scope of computer-readable medium.

In addition to storage on computer readable medium, instructions and/or data may be provided as signals on transmission media included in a communication apparatus. For example, a communication apparatus may include a transceiver having signals indicative of instructions and data. The instructions and data are configured to cause one or more processors to implement the functions outlined in the claims.

Although the present disclosure and its advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the present invention, disclosure, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

1. A machine of console comprising:
a processor; and
a machine readable medium accessible by the processor, the processor being adapted to execute instructions including
categorizing incidents based on parameters of the incidents;
identifying solutions, at least partially, based on the categorization of the incidents;
measuring mean time to restoration;
monitoring post-restoration incidents over a period of time; and
storing effective solutions into a database corresponding to the category.

2. The machine according to claim 1, wherein the processor being adapted to further execute instruction including
triggering an alert when an incident count of category exceeds a predetermined threshold for the category.

3. The machine according to claim 1, wherein the processor being adapted to further execute instruction including
determining whether incidents of the category has decreased.

4. The machine according to claim 1, wherein the processor being adapted to further execute instruction including
analysing whether the solutions are effective, wherein the analysis includes comparing whether a count of the incidents over a period of time drops below a second predetermined threshold.

5. The machine according to claim 1, wherein the processor being adapted to further execute instruction including
recording an effective solution.

6. The machine according to claim 1, wherein the processor being adapted to further execute instruction including
storing effective solutions into a database corresponding to the category.

7. The machine according to claim 1, wherein the processor being adapted to further execute instruction including
working with affected clients or venders to determine means to achieve improvement and ensure successful quality controls.

8. A machine readable memory medium of a console including instructions when executed cause a processor of the console to perform the following actions:
categorizing incidents based on parameters of the incidents;
identifying solutions, at least partially, based on the categorization of the incidents;
measuring mean time to restoration;
monitoring post-solution incidents over a period of time; and
storing effective solutions into a database corresponding to the category.

9. The machine readable memory medium according to claim 1 further including instructions:
triggering an alert when an incident count of category exceeds a predetermined threshold for the category.

10. The machine readable memory medium according to claim 1 further including instructions:
determining whether incidents of the category has decreased.

11. The machine readable memory medium according to claim 1 further including instructions:
analysing whether the solutions are effective, wherein the analysis includes comparing whether a count of the incidents over a period of time drops below a second predetermined threshold.

12. The machine readable memory medium according to claim 1 further including instructions:
recording an effective solution.

13. The machine readable memory medium according to claim 1 further including instructions:
storing effective solutions into a database corresponding to the category.

14. The machine readable memory medium according to claim 1 further including instructions:
working with affected clients or venders to determine means to achieve improvement and ensure successful quality controls.

15. A control method of a console machine having a processor, the control method comprising
categorizing incidents based on parameters of the incidents;
identifying solutions, at least partially, based on the categorization of the incidents;
measuring mean time to restoration;
monitoring post-solution incidents over a period of time; and
storing effective solutions into a database corresponding to the category.

16. The control method according to claim 15, including
triggering an alert when an incident count of category exceeds a predetermined threshold for the category.

17. The control method according to claim 15, including
determining whether incidents of the category has decreased.

18. The control method according to claim 15, including
analysing whether the solutions are effective, wherein the analysis includes comparing whether a count of the incidents over a period of time drops below a second predetermined threshold.

19. The control method according to claim 15, including
recording an effective solution.

20. The control method according to claim 15, including
storing effective solutions into a database corresponding to the category.
